(19) United States
(12) Patent Application Publication
(10) Pub. No.: US 2019/0054492 A1
(43) Pub. Date: Feb. 21, 2019

(54) PIEZOELECTRIC TWO-PHASE FLOW ULTRASONIC ATOMIZATION NOZZLE

(71) Applicant: JIANGSU UNIVERSITY, Zhenjiang (CN)

(72) Inventors: Jianmin GAO, Zhenjiang (CN); Junlong MA, Zhenjiang (CN)

(73) Assignee: JIANGSU UNIVERSITY, Zhenjiang (CN)

(21) Appl. No.: 16/081,423

(22) PCT Filed: Aug. 31, 2016
(86) PCT No.: PCT/CN2016/097486

§ 371 Date: Aug. 31, 2018

(30) Foreign Application Priority Data
May 13, 2016 (CN) 201610319946.3

(51) Int. Cl. B05B 17/06; B05B 7/12

(52) U.S. Cl. CPC B05B 17/0607; B05B 17/0623; B05B 7/12

(57) ABSTRACT

Disclosed is a piezoelectric two-phase flow ultrasonic atomization nozzle, comprising a piezoelectric vibrator (6), an amplitude transformer (8), a second end cap (12) and a first end cap (14). The piezoelectric vibrator (6) and the amplitude transformer (8) are connected via a connecting bolt (4). An air inlet connector (2) is installed at a tail portion of the connecting bolt (4). The second end cap (12) is fixed to the front end of the amplitude transformer (8). A Laval type valve core (9) is fixed in a stepped hole of the amplitude transformer (8) and a groove of the second end cap (12). A liquid inlet hole (10) is arranged in a wall face of the stepped hole of the amplitude transformer (8). A plurality of flow guide holes (11) is formed at the positions, close to an outlet, of the Laval type valve core (9) in the radial direction. The second end cap (12) is connected to the first end cap (14) in a threaded manner. A radial positioning ring (20) is arranged at a snapping groove of the back end of the first end cap (14). A step type taper valve (21) is installed on the radial positioning ring (20). The step type taper valve (21) and a vibration baffle (19) are connected via an adjusting bolt (16). A resonance chamber (17) is formed between the vibration baffle (19) and the top end of the first end cap (14). A plurality of hoses (15) is arranged in the resonance chamber (17). According to the piezoelectric two-phase flow ultrasonic atomization nozzle, a large number of superfine fog droplets can be generated in a low-energy-consumption operating condition, and the shortcoming that large atomization amount, small grain size, low energy consumption and directed spraying cannot be considered at the same time in the traditional technology is overcome.

### BACKGROUND

### Technical Field

The present invention belongs to the field of ultrasonic atomization nozzle technology. In particular, it relates to a piezoelectric two-phase ultrasonic atomizing nozzle.

### Related Art

At present, in the ultrasonic atomization technology field, there are mainly two methods for generating ultrasonic vibrations: one is to use electro-acoustic transducers to generate ultrasonic waves, and the other is to use fluids power to generate ultrasonic waves. The two methods have their own advantages and disadvantages. The droplet generated by atomizing nozzles of the electroacoustic transducer is uniform and the energy consumption is small. The particle size of the droplets changes with the design frequency of the piezoelectric vibrator (6), and the higher the frequency, the smaller the droplet size. However, the disadvantage is that the amount of atomization is small, and the droplets drift freely without direction. Fluid-power ultrasonic atomization can produce large amount of atomization and can be sprayed to a specified area directly, and its disadvantage is that if the gas pressure is low, the droplet size is coarse and uneven. So massive high pressure compressed air should be provided to get fine droplets, which is high energy consumption.

### SUMMARY

In view of the existing atomization technology, the present available atomization nozzle has the disadvantage that they can not generate large amount of atomization, ultra-small droplets size and directional spraying under low power consumption. Thus, the present invention provides a piezoelectric two-phase flow ultrasonic atomizing nozzle which is the combination of fluid-power and piezoelectric ultrasonic atomization. However, the nozzle can produce a large number of ultra-fine droplets and directional spraying under low power consumption.

Furthermore, the present invention achieves the above technical purposes through the following technical means.

The piezoelectric two-phase flow ultrasonic atomizing nozzle includes air inlet joint (2), connecting bolt (4), piezoelectric vibrator (6), horn (8), Laval valve core (9), stepped cone valve (21), second end cap (12) and first end cap (14). The piezoelectric vibrator (6) and the born (8) are fixedly connected by a hollow connecting bolt (4); the tail of the connecting bolt (4) is connected with the air inlet joint (2); the front end of the horn (8) is fixedly connected with the second end cap (12); the Laval valve core (9) is fixed in a stepped hole at the top of the horn (8) for one end, and the other end is fixed in the groove of the rear end surface of the second end cap (12); several liquid inlet holes (10) is provided in the horn (8) step hole inner surface; several diversion holes are formed in the radial direction near the outlet of the Laval valve core (9); a ring cavity is formed between the outer surface of the Laval valve core (9) and the inner surface of the stepped hole of horn (8); the center hole of second end cap (12) is conical; the second end cap (12) is connected by thread to the first end cap (14); a radial positioning ring (20) is provided at the snap groove at the rear end of the first end cap (14); a stepped cone valve (21) is installed on the radial positioning ring (20); a threaded hole is provided at the bottom of the stepped cone valve (21); the stepped cone and vibration separator plate is connected through an adjusting bolt; a resonance chamber (17) is formed between the vibration separator plate and the top of the first end cap (14); a plurality of hose (15)s are arranged in the resonance chamber (17); one end of the hose (15) is connected to the hole in the vibration separator plate, the other end is connected to the hole in the first end cap (14).

The taper angle of the stepped cone valve (21) is 40°, the conical surface is stepped type, the height and the width of the step are both 1.5 mm, and the bottom of the stepped cone valve (21) uniformly distributes three positioning keys along the circumference; the positioning ring is evenly provided with three rectangular slots along the circumference; the three positioning keys of the stepped cone valve (21) are respectively located in three rectangular slots of the radial positioning ring (20); the taper angle of the second end cap (12) is 40°, and its hole inlet diameter is 4.5 mm.

The vibration separator plate (19) is circular, and five through holes are uniformly opened; the first end cap (14) is a circular end cap, and five through holes are evenly opened; five hoses (15) is provided in the resonance chamber (17) and the inlet and outlet connecting line of the hose (15) form an angle of 21° with the axis of the first end cap (14). The hose (15), the first end cap (14) and the vibration separator plate (19) are connected by instant plugs.

The inlet diameter of the contraction section of the Laval valve core (9), the throat diameter and the outlet diameter of the expansion section are 5 mm, 2 mm and 3.5 mm respectively; the Laval valve core (9) is provided with a boss at the inlet end and the outlet end, and the inlet end boss is fixed in the rear end of the stepped hole at the top of the horn (8), and the boss at the exit end is stuck in the groove of the second end cap (12).

The liquid inlet hole (10) is located at the center of the hole wall surface of the stepped hole of the horn (8), the thickness of the ring cavity is 1.3-1.7 mm, and the diameter of the flow hole is 1.5-2 mm; 3-5 diversion holes (11) are evenly distributed in the radial direction near the outlet of the Laval valve core (9).

The outer surface of the open end of the first end cap (14) is conical, and both the first end cap (14) and the outer end of the second end cap (12) are sleeved with a lock nut (13). The contact surface between the lock nut (13) and the first end cap (14) is a conical surface and the conical angle of the inner conical surface is 10-15°, which is equal to the conical angle of the outer conical surface of the first end cap (14).

Further, the inner conical surface of the lock nut (13) is an eccentric structure, and its axis is deviated from the axis of the outer conical surface of the first end cap (14) by 1-1.2 mm; a flange (18) is provided on the outer surface of the first end cap (14).

The piezoelectric vibrator (6) includes a piezoelectric vibrator rear cover (1), a copper electrode (5), a piezoelectric vibrator front cover (7), and two piezoelectric ceramic annular plates; and the piezoelectric vibrator rear cover (1), the copper electrode (5), the piezoelectric vibrator front cover (7), the horn (8), the second end cap (12) and piezoelectric ceramic annular plates are fixedly connected by metal glue.

Further, the material of the first end cap (14), the second end cap (12), and the vibration separator plate (19) are made of stainless steel 304; the horn (8) is a stepped horn (8) with a conical transition surface and is made of aluminum 7075.

Further, the distance L from the rear end of the piezoelectric vibrator (6) to the front end of the horn (8) is 94 mm; the length L1 of the horn (8) is 66 mm, a wavelength of the sonic wave of the horn (8), and the diameter of the small end of the horn (8) is 19 mm; the distance L2 from the lower end surface of the second end cap (12) to the upper end surface of the first end cap (14) is 26 mm, half of the wavelength of the sonic wave of the second end cap (12) and the first end cap (14); the diameter of the piezoelectric resonator is 30 mm, the same as the diameter d1 of the horn (8); the diameter d2 of the center hole of the connecting bolt (4) and the horn (8) is 5 mm.

The beneficial effects of the present invention are as follows:

(1) Utilizing the piezoelectric two-phase flow ultrasonic atomizing nozzle of the present invention, first atomization of liquid is performed under the action of the strong energy of the ultrasonic wave. And the second atomization occurs when droplets hit the stepped cone valve (21) again under the supersonic airflow; and then the droplets group produced in previous two stages enter the hoses (15) in the resonance chamber (17) under the action of high-pressure air. When the eigenfrequency of the resonance chamber (17) is equal to the pulsation frequency of the two-phase fluid, resonance will occur. The droplets in the resonance chamber (17) achieve a third atomization. After tri-atomization, droplets fly out of the nozzle to hit the end surface of the closed end of the first end cap (14) and be atomized fourth due to ultrasonic vibration. Compared to the traditional piezoelectric ultrasonic atomizer, the present invention has a larger atomization quantity and smaller droplet size.

(2) Under the action of the horn (8), ultrasonic axial vibration occurs in the second end cap (12) and the stepped cone valve (21). However, due to the difference in the amplitudes of the second end cap (12) and the stepped cone valve (21), the cross-sectional area of the annular channel changes periodically. And when the two-fluid jet from the outlet of the expansion section of the Laval valve core (9) enters the annular channel between the conical surface of the stepped cone valve (21) and the second end cap (12), pressure fluctuation occurs. Under the action of the periodic pressure fluctuation, it becomes an ultrasonic pulsating fluid. The airflow has a positive effect on the further breakdown of the droplets. A resonance chamber (17) is added at the exit of the nozzle, droplets atomized three times are further broken down in the resonance chamber (17) under the action of sound waves which leads the droplets to be more uniform.

(3) A stepped cone valve (21) is arranged at the front end of the Laval valve core (9), which leads that the two-phase fluid coming out of the Laval valve core (9) has more chances crashes into the cone valve at high speed while flying through the annular channel and the droplets are further break.

(4) Compared to the resonance mode of the conventional Hartmann-type resonant cavity, in present invention, pressure fluctuation occurs when the two-phase fluid enters the annular channel between the tapered face of the stepped cone valve (21) and the inner conical surface of the second end cap (12). The oscillation state is affected by various factors such as the air supply pressure, liquid supply pressure, air supply quantity and liquid density. At the same time, due to the periodic pressure pulsation described in (2), periodic vibration of the vibration separator plate of the resonance chamber (17) and resonance occur when the eigenfrequency of the resonance chamber (17) coincides with the pulsation frequency of the two-phase fluid. The fluctuating frequency of the two-phase fluid is greatly affected by the ambient temperature, and the eigenfiequency of the resonance chamber (17) is basically constant, so it is difficult for traditional fluid-dynamic ultrasonic atomizing nozzle to generate ultrasonic vibration in the resonance chamber (17). The two-fluid pulsation frequency of the present invention is mainly affected by the axial vibration frequency of the horn (8), and the dependence on environmental temperature and other factors is greatly reduced.

### BRIEF DESCRIPTION OF THE DRAWINGS

The present disclosure will be described with reference to the accompanying drawings, wherein like numbers reference like elements.

The present invention achieves the above technical purpose through the following technical means which are further described with reference to the accompanying drawings, wherein like numbers reference like elements.

FIG. 1 is the schematic diagram of piezoelectric two-phase flow ultrasonic atomizing nozzle.

FIG. 2 is a partial enlarged view of A in FIG. 1.

FIG. 3 is an exploded view of B in FIG. 2.

FIG. 4 is a schematic assembly diagram of stepped cone valve (21) and radial positioning ring (20).

FIG. 5 shows the relationship between the cross-sectional position of the nozzle and its corresponding axial displacement amplitude.

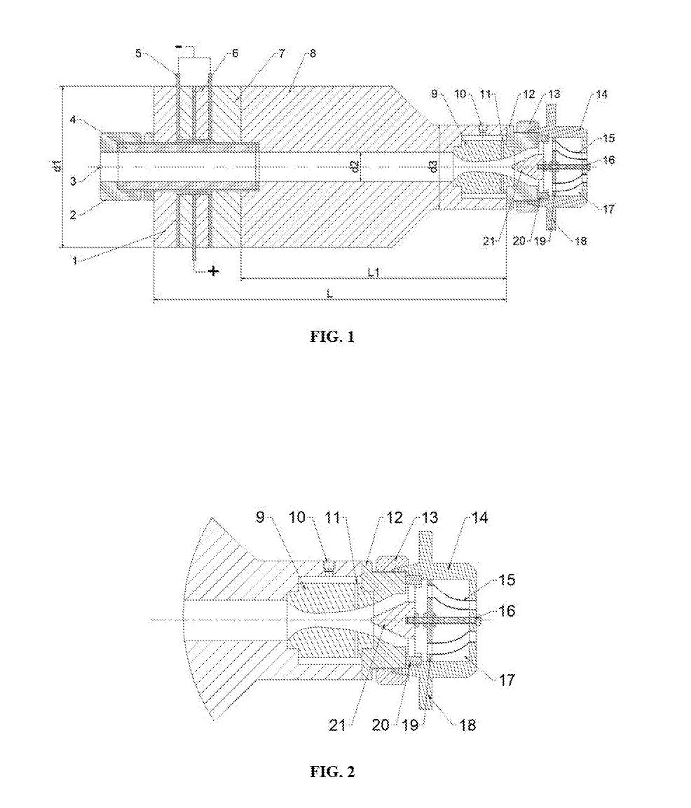

In the FIG. 1, 1—piezoelectric vibrator rear cover; 2—air inlet joint; 3—air inlet; 4—connecting bolt; 5—copper electrode; 6—piezoelectric vibrator; 7—piezoelectric vibrator front cover; 8—Horn; 9—Laval valve core; 10—liquid inlet; 11—diversion hole; 12—second end cap; 13—locknut; 14—first end cap; 15—hose; 16—adjusting bolt; 17—resonance chamber, 18—flange; 19—vibration separator plate; 20—radial positioning ring; 21—stepped cone valve.

### DESCRIPTION OF EXEMPLARY EMBODIMENTS

The present invention is further explained by the following combined with the drawings and the specific embodiments, but the protection scope of the invention is not limited to this.

As shown in FIG. 1 and FIG. 2, a piezoelectric two-phase flow ultrasonic atomizing nozzle includes an air inlet joint (2), a connecting bolt (4), a piezoelectric vibrator (6), a horn (8), a Laval valve core (9), and a stepped cone valve (21), a second end cap (12) and a first end cap (14); the piezoelectric vibrator (6) and the horn (8) are fixedly connected by a connection bolt (4); the tail of the connecting bolt (4) is connected with the air inlet joint (2). The front end of the horn (8) is fixedly connected to the second end cap (12) with metal glue. The horn (8) is stepped shape with a conical transitional surface, and the material is aluminum 7075; the length L1 of the horn (8) is 66 mm, a wavelength of sonic wave at the horn (8). The diameter of the small end of horn (8) is 19 mm; a stepped hole is machined on the top of the horn (8), the depth of the stepped hole is 10-13 mm; the liquid inlet hole (10) is opened at the inner surface of the stepped hole of the horn (8), and the liquid inlet hole (10) is corresponding to the axis of the Laval valve core (9); The rear end surface of the second end cap (12) is provided with a groove, the middle hole of the second end cap (12) 12 is conical, whose cone angle is 40°, and the conical bore inlet diameter is 4.5 mm. The Laval valve core (9) has a constriction section inlet at diameter of 5 mm, a throat at diameter of 2 mm, and an axial length of the constriction section is 4-6 times the throat diameter. The outlet diameter of the dilatation section is 3.5 mm. The design of the dilatation section is a Vitosinski curve, and the throat area is designed as an arc. The inlet and outlet end of the Laval valve core (9) are provided with bosses, the inlet end boss is stuck in the rear end of the stepped hole in horn (8), and the outlet end boss is stuck in the recesses in the second end cap (12). This ensures the concentricity of the Laval valve core (9) with the outer circumference of the nozzle when it is installed. The Laval valve core (9) has three diversion holes (11) in the radial direction near the outlet. The diameter of the diversion hole (11) is 1.5-2 mm. A ring cavity is formed between the inner circular surfaces of the stepped holes of horn (8) and outer surface of Laval valve core (9).

The second end cap (12) is connected to the first end cap (14) by thread; the outer surface of the open end of the first end cap (14) is conical, and the first end cap (14) and the second end cap (12) 12 are sleeved with lock nut (13) on the outer side; the contact area of the lock nut (13) and the first end cap (14) is an inner conical surface, and the conical angle of the inner conical surface is 10-15° equal to the conical angle of the outer conical surface of the first end cap (14). The concave surface of the lock nut (13) is eccentric so that the lock nut (13) wedges the first end cap (14) like a wedge to prevent the first end cap (14) from loosening. The thickness of the ring cavity is 1.3-1.7 mm, so the thickness of liquid film in the ring cavity is 1.3-1.7 mm. The liquid film will be atomized due to ultrasonic vibration of the end face of the first end cap (14).

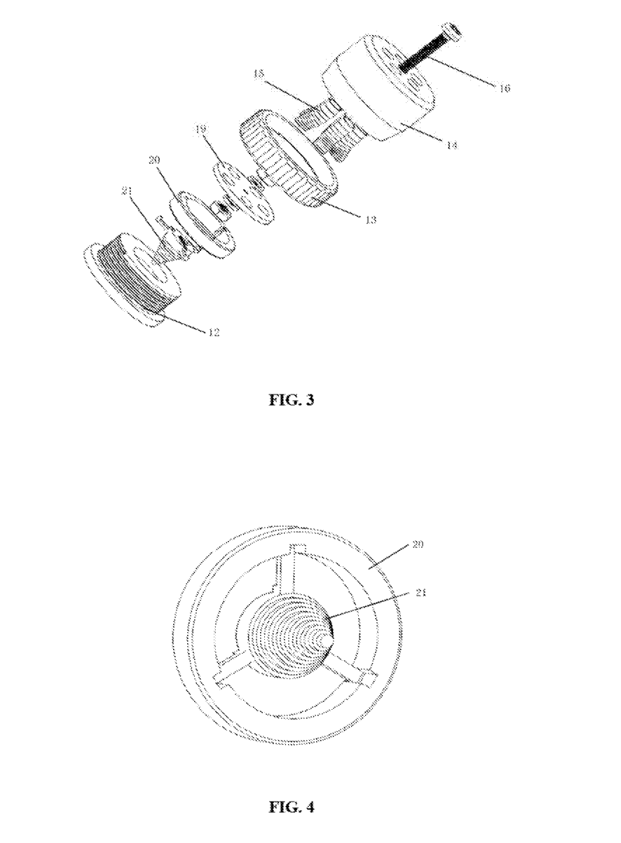

A radial positioning ring (20) is arranged at the clamping groove at the rear end of the first end cap (14); as shown in FIG. 3 and FIG. 4, the cone angle of the stepped cone valve (21) is 40°, the conical surface is stepped, and the height and width of the step are both 1.5 mm. Three positioning keys is evenly distributed along the circumference at the bottom of the stepped cone valve (21); the radial positioning ring (20) is evenly provided with three rectangular slots along the circumference. The three keys are equipped in the three rectangular slots of the radial positioning ring (20) respectively. And the position of the stepped cone valve (21) relative to the outlet of the Laval valve core (9) can be adjusted along the axis via the adjusting bolt (16). At the same time, the outlet cross-sectional area of the Laval valve core (9) also changes accordingly, regulating the speed of the fluid at the outlet of the Laval valve core (9). The axial adjustment range of the stepped cone valve (21) is 0-6 mm, ensuring that the fluid speed at the outlet of the Laval valve core (9) varies from Mach 1.8 to Mach 2.2.

The theoretical basis is as follows:

Q=AρV,

Where, Q is the flow rate, A is the cross-sectional area of the tube, and V is the air flow velocity at section A.

According to the gas movement Euler equation: dP=−dVρV

$$Derived \frac{dA}{A} = ( {M}^{2} - 1 ) \frac{dV}{V} ,$$

M is the Mach number,

Therefore, when the velocity of the fluid is greater than the speed of sound, the velocity of the fluid becomes larger as the sectional area becomes larger and becomes smaller as the sectional area becomes smaller. When the fluid velocity is less than the sonic speed, the fluid velocity becomes smaller as the sectional area becomes smaller and vice versa.

Then according to the Laval nozzle section ratio formula:

$$\frac{A}{{A}^{*}} = {\frac{1}{M} [ ( \frac{2}{γ + 1} ) ( 1 + \frac{γ - 1}{2} {M}^{2} ) ]}^{\frac{γ + 1}{2 ( γ - 1 )}}$$

Where A is the cross-sectional area of the pipe at any location, A* is the cross-sectional area of the throat pipe, γ is the specific heat capacity ratio, and M is the fluid Mach number at any position of the pipe. The specific heat capacity ratio of air taken is γ=1.4, the initial diameter of the expansion section of the Laval tube is 3.5 mm, and the throat diameter is 2 mm. The Mach number at the outlet of the expansion section of the Laval tube is 2.2 mm. At the same time, the axial direction of the stepped cone valve (21) is adjusted. The position changes the cross-sectional area of the flow channel at the outlet of the Laval tube, ranging from 4.5 to 9.6 mm². At the same time, the fluid velocity at the outlet changes from 1.8 Mach 2.2 to 2.2 Mach accordingly.

There is a threaded hole at the bottom of the stepped cone valve (21), and the vibration separator plate (19) has a threaded hole at the center. The stepped cone valve (21) and the vibration separator plate (19) are connected through the adjusting bolt (16). The vibration separator plate (19) is a circular plate, and five through holes are evenly opened; the first end cap (14) is a round end cap, and five through holes are uniformly opened; a resonance chamber (17) is formed between the front end of the first end caps (14) and vibration separator plate (19). The eigenfrequency of the resonance chamber (17) is between 55 and 65 kHz. Five hoses (15) are disposed in the resonance chamber (17), and one end of each hose (15) is connected to the through hole of the vibration separator plate (19) and the other end is connected to the through hole of the first end cap (14). The connecting line between inlet and the outlet of the hose (15) makes an angle of 21° with the axis of the first end cap (14). The hose (15) is connected with the vibration separator plate (19) and the first end cap (14) by a plug. When adjust the axial position of vibration separator plate (19), the plastic hose (15) is stretched and compressed correspondingly. A flange (18) is provided on the outer surface of the first end cap (14). The flange (18) is used to limit the axial amplitude of the first end cap (14), which will reduce the vibration of the horn (8) influencing eigenfrequency of the resonance chamber (17).

The piezoelectric vibrator (6) includes a piezoelectric vibrator rear cover (1), three copper electrodes (5) and a piezoelectric vibrator front cover (7). The vibration frequency of the main body of the ultrasonic atomizing nozzle composed of piezoelectric vibrator (6) and the horn (8) 8 is 55-65 kHz. The piezoelectric vibrator rear cover (1), the three copper electrodes (5), the piezoelectric vibrator front cover (7) and the horn (8) are fixedly connected by metal glue. The material of the first end cap (14), the second end cap (12), and the vibration separator plate (19) are all made of stainless steel 304.

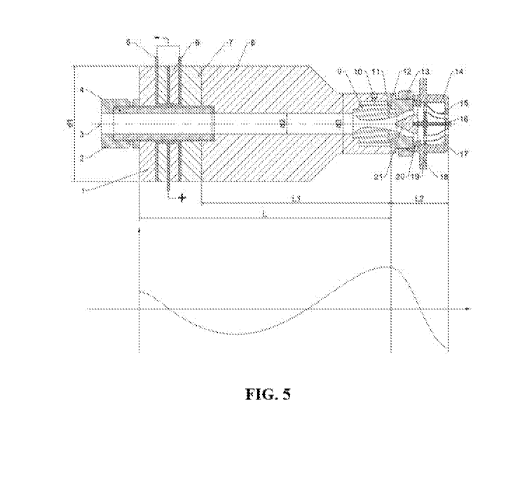

As shown in FIG. 5, the distance L from the rear end of the piezoelectric vibrator (6) to the front end of the horn (8) is 94 mm; the distance L2 from the rear end of the second end cap (12) to the front end of the first end cap (14) is 26 mm, half of sonic wavelength. The diameter of the piezoelectric vibrator (6) is 30 mm, the same as the diameter d1 of the horn (8). The inner diameter d2 of the connecting bolt (4) and the horn (8) is 5 mm. The high-pressure gas of the present invention is supplied by an air compressor, and the intake pipe is connected with the air inlet (3) of the nozzle; the liquid to be atomized is pumped by pump to the liquid inlet (10); the main body of the ultrasonic atomizing nozzle is driven by an ultrasonic driving power, and the first and third copper electrode (5) are connected to the negative electrode of the power supply, and the second copper electrode is connected to the positive electrode of the power supply. The driving frequency of ultrasonic driving power is 55-65 kHz.

Work Process:

High-pressure gas (4.5-5.5 bar) enters through the air inlet joint (2) at the end of the nozzle. The gas is accelerated to supersonic speed (1.8-2.2 Mach) after pass through Laval valve core (9), and the liquid is pumped to the liquid inlet (10). The liquid fills the gap between the Laval valve core (9) and the inner surface of the stepped hole of the horn (8), and consequentially passes through the diversion hole (11), and consequentially liquid flows into the Laval valve near the outlet of the Laval valve core (9) and merges with the supersonic air flow. By now the first atomization is achieved. Then the atomized droplets collide with the stepped cone valve (21) with the high velocity airflow and the bi-atomization is achieved. Pressure fluctuations occurs when the two-phase fluid enters the annular channel between the tapered face of the stepped cone valve (21) and the inner conical surface of the second end cap (12). At the same time, under the action of the horn (8), the axial vibration occurs in the second end cap (12) and the stepped cone valve (21). However, due to the difference in the amplitudes of the second end cap (12) and the stepped cone valve (21), the channel cross-sectional area of the annular channel changes periodically. And when the two-fluid jet from the outlet of the expansion section of the Laval valve core (9) enters the annular channel between the conical surface of the stepped cone valve (21) and the second end cap (12), pressure fluctuation occurs. Under the action of the periodic pressure fluctuation, it becomes a supersonic pulsating fluid. Then periodic vibration of the vibration separator plate of the resonance chamber (17) occurs, and resonance occurs when the eigenfrequency of the resonance chamber (17) coincides with the pulsation frequency of the two-phase fluid. Droplets bi-atomized flow into the hoses (15) in resonance chamber (17) under the action of high pressure gas and tri-atomized. It should be noted that the pulse state of the two-phase fluid and the eigenfrequency of the resonance chamber (17) is affected by such factors as pressure, temperature, and liquid density, so the resonance point needs to be found trial. The first end cap (14) is ultrasonically vibrated in the axial direction under the action of the piezoelectric vibrator (6). Droplets tri-atomized flow out of nozzle, and a part of the droplets impact on the end surface of the first end cap (14) and atomized fourth under the effect of the ultrasonic vibration. At the same time, the liquid film remaining on the end surface of the first end cap (14) is also atomized under the effect of the ultrasonic vibration. Each atomization can further reduce the particle size of the droplets with larger diameters in the droplet group. After atomized fourth, the droplet sizes of the droplets become more uniform and the amount of atomization increases significantly.

1. A piezoelectric two-phase flow ultrasonic atomizing nozzle comprising: air inlet joint (2), connecting bolt (4), piezoelectric vibrator (6), horn (8), Laval valve core (9), stepped cone valve (21), second end cap (12), and first end cap (14), the piezoelectric vibrator (6) and the horn (8) are fixedly connected by a hollow connecting bolt (4); the tail of the connecting bolt (4) is connected with the air inlet joint (2); the front end of the horn (8) is fixedly connected with the second end cap (12); the Laval valve core (9) is fixed in a stepped hole at the top of the horn (8) for one end, and the other end is fixed in the groove of the rear end surface of the second end cap (12); liquid inlet (10) is machined in the step hole inner surface of horn (8); diversion holes (11) are arranged in the radial direction near the outlet of the Laval valve core (9); a ring cavity is formed between the outer surface of the Laval valve core (9) and the inner surface of the stepped hole of horn (8); the center hole of second end cap (12) is conical; the second end cap (12) is connected to the first end cap (14) by thread; a radial positioning ring (20) is provided at the snap groove at the rear end of the first end cap (14); a stepped cone valve (21) is installed on the radial positioning ring (20); a thread hole is provided at the bottom of the stepped cone valve (21); the stepped cone valve (21) are connected with vibration separator plate (19) by an adjusting bolt (16); a resonance chamber (17) is formed between the vibration separator plate (19) and the top of the first end cap (14); hoses (15) are arranged in the resonance chamber (17) evenly; one end of the hose (15) is connected to the hole in the vibration separator plate (19), the other end is connected to the hole in the first end cap (14).

2. The piezoelectric two-phase flow ultrasonic atomizing nozzle according to claim 1, wherein:
the taper angle of the stepped cone valve (21) is 40°, the conical surface is stepped, the height and the width of the step are both 1.5 mm, and the bottom of the stepped cone valve (21) uniformly distributes three positioning keys along the circumference; the radial positioning ring (20) has three rectangular slots located its circumference evenly; the three positioning keys of the stepped cone valve (21) are respectively located in three rectangular slots of the radial positioning ring (20); the taper angle of the second end cap (12) is 400, and its hole inlet diameter is 4.5 mm.

3. The piezoelectric two-phase flow ultrasonic atomizing nozzle according to claim 1, wherein:
the vibration separator plate (19) is circular, and five through holes are distributed evenly; the first end cap (14) is a circular end cap, and five through holes are evenly distributed on it; five hoses (15) are provided in the resonance chamber (17), the inlet and outlet connecting line of the hose (15) are at an angle of 21° with the axis of the first end cap (14).

4. The piezoelectric two-phase flow ultrasonic atomizing nozzle according to claim 1, wherein:
the inlet diameter of the contraction section, the throat diameter and the outlet diameter of the expansion section of the Laval valve core (9) are 5 mm, 2 mm, and 3.5 mm respectively; the Laval valve core (9) has boss at the inlet end and the outlet end, and the inlet end boss is fixed in the rear end of the stepped hole at the top of the horn (8), and the boss at the exit end is stuck in the groove of the second end cap (12).

5. The piezoelectric two-phase flow ultrasonic atomizing nozzle according to claim 1, wherein:
the liquid inlet hole (10) is located at the center of the hole wall surface of the stepped hole of the horn (8), the thickness of the ring cavity is 1.3-1.7 mm, and the diameter of the diversion hole (11) is 1.5-2 mm; 3-5 diversion holes (11) are circumferentially even-distributed near the outlet the Laval valve core (9).

6. The piezoelectric two-phase flow ultrasonic atomizing nozzle according to claim 1, wherein:
the outer surface of the open end of the first end cap (14) is conical, the first end cap (14) and the outer end of the second end cap (12) are sleeved with a lock nut (13); the contact surface of the lock nut (13) and the first end cap (14) is conical and the conical angle is 10-15°, equal to the outer conical angle of the first end cap (14).

7. The piezoelectric two-phase flow ultrasonic atomizing nozzle according to claim 6, wherein:
further, the inner conical surface of the lock nut (13) is an eccentric structure, and its axis is deviated from the axis of the outer conical surface of the first end cap (14) by 1-1.2 mm a flange (18) is provided on the outer surface of the first end cap (14).

8. The piezoelectric two-phase flow ultrasonic atomizing nozzle according to claim 1, wherein:
the piezoelectric vibrator (6) includes a piezoelectric vibrator rear cover (1), a copper electrode (5), a piezoelectric vibrator front cover (7) and two pieces of piezoelectric ceramic annular plates; and the piezoelectric vibrator rear cover (1), the copper electrode (5), the piezoelectric vibrator front cover (7), the horn (8), the second end cap (12) and piezoelectric ceramic annular plates are fixedly connected by metal glue.

9. The piezoelectric two-phase flow ultrasonic atomizing nozzle according to claim 1, wherein:
the first end cap (14), the second end cap (12), and the vibration separator plate (19) are all made of stainless steel 304; the horn (8) is stepped with a conical transition surface, and is made of aluminum 7075.

10. The piezoelectric two-phase flow ultrasonic atomizing nozzle according to claim 1, wherein:
the distance L from the rear end of the piezoelectric vibrator (6) to the front end of the horn (8) is 94 mm; the length L1 of the horn (8) is 66 mm, a wavelength of the sonic wave of aluminum 7075, and the diameter of the small end of the horn (8) is 19 mm the distance L2 from the lower end surface of the second end cap (12) to the upper end surface of the first end cap (14) is 26 mm, half of the sonic wavelength of stainless steel 304; the diameter of the piezoelectric resonator is 30 ran, the same as the diameter d1 of the horn (8); the diameter d2 of the center hole of the connecting bolt (4) and the horn (8) is 5 mm.
